(19) United States
(12) Patent Application Publication
(10) Pub. No.: US 2016/0245975 A1
(43) Pub. Date: Aug. 25, 2016

(54) Backlight Module and Liquid Crystal Display Device

(71) Applicant: SHENZHEN CHINA STAR OPTOELECTRONICS TECHNOLOGY CO., LTD., Shenzhen, Guangdong (CN)

(72) Inventor: Quan LI, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/379,821

(22) PCT Filed: May 16, 2014
(86) PCT No.: PCT/CN2014/077660

§ 371 Date: Aug. 20, 2014

(51) Int. Cl. F21V 8/00

(52) U.S. Cl. CPC G02B 6/0021; G02B 6/0023; G02B 6/002; G02B 6/0085; G02B 6/0091; G02B 6/0055

(57) ABSTRACT

The present invention provides a backlight module, which comprises a back board, a light guide plate, a light source, a middle frame and a quantum bar; wherein the light guide plate is disposed between the back board and the middle frame, which comprises the incident light side and the light emitting side, the incident light side is close to the light source, which is provided with a groove of which the opening faces to the middle frame; the quantum bar accommodates in the cavity of the groove, one end of which abut with the bottom of the inner wall of groove; the middle frame cover is disposed on the light guide plate and the light source, one side of which facing to the back board is provide with a first buffer block abutting on the other end of the quantum bar. The present invention also provides a liquid crystal display device. The backlight module and the liquid crystal display device provided by the embodiment of the present invention can firmly fix the quantum dot in the backlight module, and it can be easily and quickly assembled.

This application submitted to Chinese Patent Office on May 12, 2014, application NO. is 201410197215.7, the title of the invention is China patent priority of “backlight module and liquid crystal display device”, the entire contents of the patent are incorporated by reference in the present application.

### BACKGROUND OF THE INVENTION

1. Field of the Invention

The present invention relates to the display technical field, and in particular to a backlight module and a liquid crystal display device.

2. The Related Arts

In the conventional liquid crystal display, the white LED is usually used to be backlight, achieving the backlight required by the liquid crystal through the reasonable combination of the light guide plate and the optical film. As the requirement of high color gamut, high color saturation and energy-saving lamps increasing, the current solutions of achieving white light source, high color gamut and high color saturation in the backlight are to combine ultraviolet LED with RGB phosphor or combine the blue LED with red and green phosphor or combine the blue LED with green LED and red LED and so on. These methods can improve the color gamut, but it is difficult to implement, and the cost is higher.

Therefore, Quantum Dot, QD, is applied to the backlight module, using the high-frequency spectrum light source (such as blue LED) to replace the traditional white LED light source, utilizing the quantum effect, under the high frequency source irradiating, the quantum dot can be arouse and generate the different wavelength spectrum, through adjusting the size of the quantum dot, it can synthesize the light color, achieving the backlight requirement of the high color gamut liquid crystal display, thereby enhancing the screen quality of the liquid crystal display. How to firmly fix the quantum dot in the backlight module is the current researching subject.

### SUMMARY OF THE INVENTION

The technical problems to be solved in the embodiment of the present invention is to provide a backlight module and a liquid crystal device, which can firmly fix the quantum dot in the backlight module, and it can be easily and quickly assembled.

In order to solve the above technical problems, first technical solution adopting by the present invention is: a backlight module, which comprises a back board, a light guide plate, a light source, a middle frame and a quantum bar;

Wherein the light guide plate is disposed between the back board and the middle frame, which comprises the incident light side and the light emitting side, the incident light side is close to the light source, which is provided with a groove of which the opening faces to the middle frame;

The quantum bar accommodates in the cavity of the groove, one end of which abut with the bottom of the inner wall of groove;

The middle frame cover is disposed on the light guide plate and the light source, one side of which facing to the back board is provide with a first buffer block abutting on the other end of the quantum bar.

Wherein the first buffer block is attached on the middle frame.

Wherein the height of the incident light side of the light guide plate is greater than the light emitting side.

Wherein the length of the quantum bar is greater than or equal to the height of the light emitting side of the light guide plate.

Wherein the incident light side of the light guide plate is provided with at least one heat sink, the heat sink is connected with the groove, and runs through the outer side wall of the incident light side of the light guide plate facing to the back board side.

Wherein the backlight module also comprises a second buffer block, the second buffer block is disposed between the back board and the incident light side of the light guide plate.

Wherein the backlight module also comprises a heat sink, the heat sink is disposed between the second buffer block and the back board.

Wherein the thickness of the light guide plate gradually decreases along with the direction of the light emitting side away from the light source.

Wherein the backlight module also comprises a reflective sheet, the reflective sheet is disposed on the one side of the light emitting side of the light guide plate facing to the back board; the material of the middle frame is made of a plastic material.

In order to solve the above technical problems, the second technical solution adopted by the present invention is: a backlight module, which comprises a back board, a light guide plate, a light source, a middle frame and a quantum bar;

Wherein the light guide plate is disposed between the back board and the middle frame, which comprises the incident light side and the light emitting side, the incident light side is close to the light source, which is provided with a groove of which the opening faces to the middle frame;

The quantum bar accommodates in the cavity of the groove, one end of which abut with the bottom of the inner wall of groove;

The middle frame cover is disposed on the light guide plate and the light source, one side of which facing to the back board is provide with a first buffer block abutting on the other end of the quantum bar, the first buffer block is attached on the middle frame.

Wherein the height of the incident light side of the light guide plate is greater than the light emitting side.

Wherein the length of the quantum bar is greater than or equal to the height of the light emitting side of the light guide plate.

In order to solve the above technical problems, the third technical solution adopted by the present invention is: a liquid crystal display device, wherein the liquid crystal display device comprises a backlight module;

The backlight module comprises a back board, a light guide plate, a light source, a middle frame and a quantum bar;

Wherein the light guide plate is disposed between the back board and the middle frame, which comprises the incident light side and the light emitting side, the incident light side is close to the light source, which is provided with a groove of which the opening faces to the middle frame;

The quantum bar accommodates in the cavity of the groove, one end of which abut with the bottom of the inner wall of groove;

The middle frame cover is disposed on the light guide plate and the light source, one side of which facing to the back board is provide with a first buffer block abutting on the other end of the quantum bar.

Wherein the first buffer block is attached on the middle frame.

Wherein the height of the incident light side of the light guide plate is greater than the light emitting side.

Wherein the length of the quantum bar is greater than or equal to the height of the light emitting side of the light guide plate.

Wherein the incident light side of the light guide plate is provided with at least one heat sink, the heat sink is connected with the groove, and runs through the outer side wall of the incident light side of the light guide plate facing to the back board side.

Wherein the backlight module also comprises a second buffer block, the second buffer block is disposed between the back board and the incident light side of the light guide plate.

Wherein the backlight module also comprises a heat sink, the heat sink is disposed between the second buffer block and the back board.

Wherein the thickness of the light guide plate gradually decreases along with the direction of the light emitting side away from the light source.

Wherein the backlight module also comprises a reflective sheet, the reflective sheet is disposed on the one side of the light emitting side of the light guide plate facing to the back board; the material of the middle frame is made of a plastic material.

The backlight module and the liquid crystal display device provided by the present invention has the following benefits: since there is a groove for accommodating the quantum bar on the light guide plate and a first buffer block which abut with the quantum bar covered and disposed on the middle frame above the light guide plate and the light source, it makes the quantum bar easily and quickly placed and firmly fixed in the groove; moreover, there is a heat sink disposed on the bottom of the groove, thereby maintaining the good heat dissipation of the quantum bar, improving its service life.

### BRIEF DESCRIPTION OF THE DRAWINGS

FIG. 1 is a structural schematic diagram of a backlight module provided by the first embodiment of the present invention;

FIG. 2 is a structural schematic diagram of a backlight module provided by the second embodiment of the present invention;

In Figure: 1—back board, 2—light guide plate, 21—incident light side, 211—groove, 212—heat sink, 22—light emitting side, 3—light source, 4—middle frame, 5—quantum bar, 6—first buffer block, 7—second buffer block, 8—cooling plate, 9—reflective sheet.

### DETAILED DESCRIPTION OF THE PREFERRED EMBODIMENTS

The following reference drawings describe the preferred embodiments of the present invention.

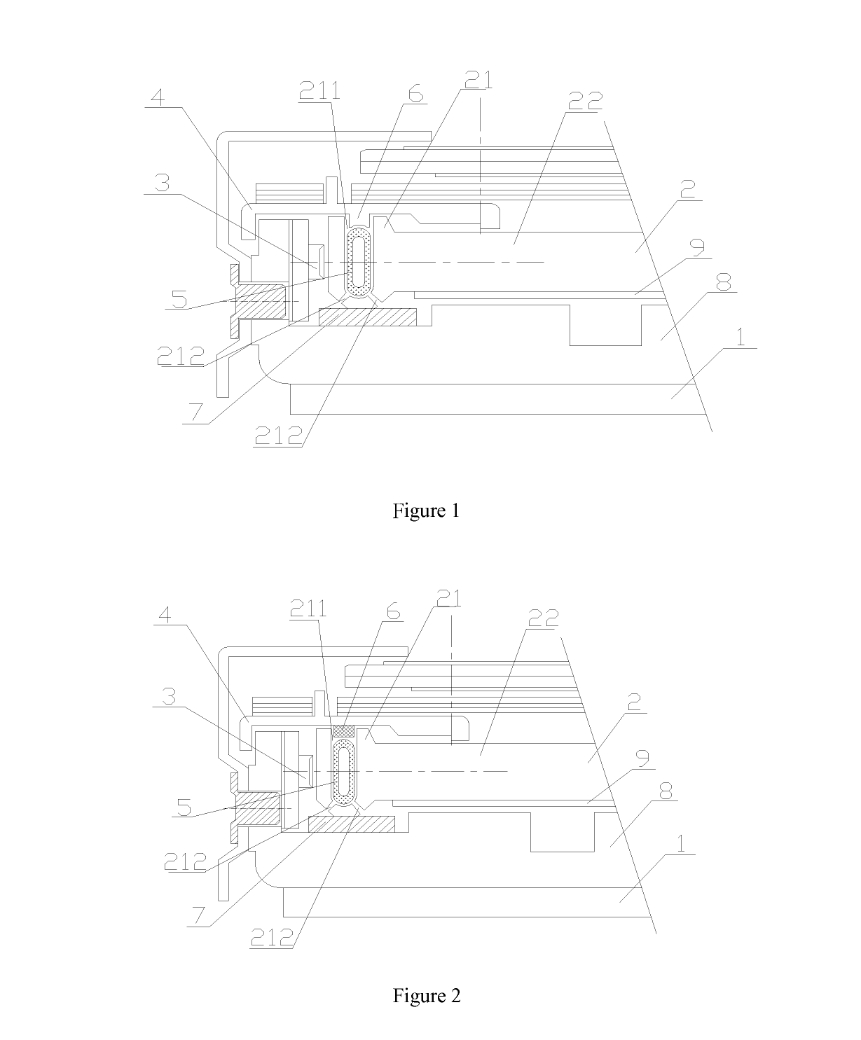

Referring to FIG. 1 and FIG. 2, which are the embodiments of the backlight module of the present invention.

As shown in FIG. 1, which is a structural schematic diagram of a backlight module provided by the first embodiment of the present invention. The backlight module in the first embodiment of the present invention can be plurality, each light source corresponds to a backlight module, for the brief description, the following description will take a backlight module for example. The backlight module provided by the first embodiment of the present invention comprises a back board 1, a light guide plate 2, a light source 3, a middle frame 4 and a quantum bar 5;

Wherein the light guide plate 2 is disposed between the back board 1 and the middle frame 4, which comprises the incident light side 21 and the light emitting side 22, the incident light side 21 is close to the light source 3, which is provided with a groove 211 of which the opening faces to the middle frame 4;

The quantum bar 5 accommodates in the cavity of the groove 211, one end of which abut with the bottom of the inner wall of groove 211;

The middle frame 4 is disposed on the light guide plate 2 and the light source 3, one side of which facing to the back board 1 is provide with a first buffer block 6 abutting on the other end of the quantum bar 5, wherein the first buffer block 6 and the middle frame 4 are integrally formed.

In order to improve the display quality of the liquid crystal display panel, it needs to achieve that the height of the light guide plate 2 on the incident light side 21 (including the quantum bar 5 side) is greater than the height of the light guide plate 2 on the light emitting side 22 (excluding the quantum bar 5 side) as possible; in particular, the length of the quantum bar 5 must be greater than or equal to the height of the light guide plate 2 light emitting side 22. It should be noted that, the height of the incident light side 21 of the light guide plate 2, the valuation directions of the height of the light guide plate 2 light emitting side 22 and the length of the quantum bar 5 are the same, the valuation direction is perpendicular to the center axis of the longitudinal direction of the light guide plate 2.

In order to maintain the quantum bar 5 having good heat dissipation, improving its service life, there is a heat sink 212 provided in the incident light side 21 of the light guide plate 2, the heat sink 212 is connected with the groove 211, and runs through the outer side wall of the incident light side of the light guide plate facing to the back board side.

Furthermore, the backlight module also comprises a second buffer block 7, the second buffer block 7 is disposed between the back board 1 and the incident light side 22 of the light guide plate 2, it can effectively slow down the extrusion between the light guide plate 2 and the back board 1,avoiding the quantum bar 5 damaged by the extrusion; wherein the first buffer block 6 and the second buffer block 7 most are foam material, the materials comprise silicone, ethylene-vinyl acetate (EVA) copo, thermoplastic polyurethanes (TPU) and so on, the materials of the first buffer block 6 and the second buffer block 7 could be different.

Furthermore, the backlight module also comprises a cooling plate 8, the cooling plate 8 is disposed between the second buffer block 7 and the back board 1, making the heat generated by the quantum bar 5 be able to more effectively discharge to the cooling plate 8 through the heat sink 212, thus achieving the cooling effect.

Furthermore, the thickness of the light guide plate 2 gradually decreases along with the direction of the light emitting side 22 away from the light source 3, thus achieving the purpose of the reducing the weight of the backlight module, it namely is designed as a wedge.

Furthermore, the backlight module also comprises a reflective sheet, the reflective sheet is disposed on the one side of the light emitting side of the light guide plate facing to the back board.

Furthermore, the material of the middle frame is made of a plastic material.

Corresponding to the backlight module of the first embodiment of the present invention, it also provides a liquid crystal display device, which includes the backlight module as described in the first embodiment of the present invention, the structure and connection of the backlight module are the same with the backlight module in the first embodiment of the present invention, here will no longer describe in detail.

As shown in FIG. 2, which is a structural schematic diagram of a backlight module provided by the second embodiment of the present invention. The backlight module in the second embodiment of the present invention can be disposed plurality, each light source corresponds to a backlight module, for the brief description, the following description will take a backlight module for example. The backlight module provided by the first embodiment of the present invention comprises a back board 1, a light guide plate 2, a light source 3, a middle frame 4 and a quantum bar 5;

Wherein the light guide plate 2 is disposed between the back board 1 and the middle frame 4, which comprises the incident light side 21 and the light emitting side 22, the incident light side 21 is close to the light source 3, which is provided with a groove 211 of which the opening faces to the middle frame 4;

The quantum bar 5 accommodates in the cavity of the groove 211, one end of which abut with the bottom of the inner wall of groove 211;

The middle frame 4 is disposed on the light guide plate 2 and the light source 3, one side of which facing to the back board 1 is provide with a first buffer block 6 abutting on the other end of the quantum bar 5, the first buffer block 6 is attached on the middle frame 4 through the double-sided tape or other ways.

In order to improve the display quality of the liquid crystal display panel, it needs to achieve that the height of the light guide plate 2 on the incident light side 21 (including the quantum bar 5 side) is greater than the height of the light guide plate 2 on the light emitting side 22 (excluding the quantum bar 5 side) as possible; in particular, the length of the quantum bar 5 must be greater than or equal to the height of the light guide plate 2 light emitting side 22. It should be noted that, the height of the incident light side 21 of the light guide plate 2, the valuation directions of the height of the light guide plate 2 light emitting side 22 and the length of the quantum bar 5 are the same, the valuation direction is perpendicular to the center axis of the longitudinal direction of the light guide plate 2.

In order to maintain the quantum bar 5 having good heat dissipation, improving its service life, there is a heat sink 212 provided in the incident light side 21 of the light guide plate 2, the heat sink 212 is connected with the groove 211, and runs through the outer side wall of the incident light side of the light guide plate facing to the back board side.

Furthermore, the backlight module also comprises a second buffer block 7, the second buffer block 7 is disposed between the back board 1 and the incident light side 22 of the light guide plate 2, it can effectively slow down the extrusion between the light guide plate 2 and the back board 1, avoiding the quantum bar 5 damaged by the extrusion; wherein the first buffer block 6 and the second buffer block 7 most are foam material, the materials comprise silicone, ethylene-vinyl acetate (EVA) copo, thermoplastic polyurethanes (TPU) and so on, the materials of the first buffer block 6 and the second buffer block 7 could be different.

Furthermore, the backlight module also comprises a cooling plate 8, the cooling plate 8 is disposed between the second buffer block 7 and the back board 1, making the heat generated by the quantum bar 5 be able to more effectively discharge to the cooling plate 8 through the heat sink 212, thus achieving the cooling effect.

Furthermore, the thickness of the light guide plate 2 gradually decreases along with the direction of the light emitting side 22 away from the light source 3, thus achieving the purpose of the reducing the weight of the backlight module, it namely is designed as a wedge.

Furthermore, the backlight module also comprises a reflective sheet, the reflective sheet is disposed on the one side of the light emitting side of the light guide plate facing to the back board.

Furthermore, the material of the middle frame is made of a plastic material.

Corresponding to the backlight module of the first embodiment of the present invention, it also provides a liquid crystal display device, which includes the backlight module as described in the first embodiment of the present invention, the structure and connection of the backlight module are the same with the backlight module in the first embodiment of the present invention, here will no longer describe in detail.

Using the backlight module and the liquid crystal display device provided by present invention has the following benefits: since there is a groove for accommodating the quantum bar on the light guide plate and a first buffer block which abut with the quantum bar covered and disposed on the middle frame above the light guide plate and the light source, it makes the quantum bar easily and quickly placed and firmly fixed in the groove; moreover, there is a heat sink disposed on the bottom of the groove, thereby maintaining the good heat dissipation of the quantum bar, improving its service life.

The ordinary technical personnel in the art can understand that all or part of the steps of the above embodiments can be accomplished through a program instructing the related hardware, the program can be stored in the readable storage medium of a computer, the storage medium, such as ROM/RAM, disk, optical disk, etc.

The preferred embodiments according to the present invention are mentioned above, which cannot be used to define the scope of the right of the present invention. Those variations of equivalent structure or equivalent process according to the present specification and the drawings or directly or indirectly applied in other areas of technology are considered encompassed in the scope of protection defined by the clams of the present invention.

What is claimed is:

1. A backlight module, wherein it comprises a back board, a light guide plate, a light source, a middle frame and a quantum bar;
wherein the light guide plate is disposed between the back board and the middle frame, which comprises the incident light side and the light emitting side, the incident light side is close to the light source, which is provided with a groove of which the opening faces to the middle frame;
the quantum bar accommodates in the cavity of the groove, one end of which abut with the bottom of the inner wall of groove;
the middle frame cover is disposed on the light guide plate and the light source, one side of which facing to the back board is provide with a first buffer block abutting on the other end of the quantum bar.

2. The backlight module as claimed in claim 1, wherein the first buffer block is attached on the middle frame.

3. The backlight module as claimed in claim 2, wherein the height of the incident light side of the light guide plate is greater than the light emitting side.

4. The backlight module as claimed in claim 3, wherein the length of the quantum bar is greater than or equal to the height of the light emitting side of the light guide plate.

5. The backlight module as claimed in claim 4, wherein the incident light side of the light guide plate is provided with at least one heat sink, the heat sink is connected with the groove, and runs through the outer side wall of the incident light side of the light guide plate facing to the back board side.

6. The backlight module as claimed in claim 5, wherein the backlight module also comprises a second buffer block, the second buffer block is disposed between the back board and the incident light side of the light guide plate.

7. The backlight module as claimed in claim 6, wherein the backlight module also comprises a heat sink, the heat sink is disposed between the second buffer block and the back board.

8. The backlight module as claimed in claim 7, wherein the thickness of the light guide plate gradually decreases along with the direction of the light emitting side away from the light source.

9. The backlight module as claimed in claim 8, wherein the backlight module also comprises a reflective sheet, the reflective sheet is disposed on the one side of the light emitting side of the light guide plate facing to the back board; the material of the middle frame is made of a plastic material.

10. A backlight module, wherein it comprises a back board, a light guide plate, a light source, a middle frame and a quantum bar;
wherein the light guide plate is disposed between the back board and the middle frame, which comprises the incident light side and the light emitting side, the incident light side is close to the light source, which is provided with a groove of which the opening faces to the middle frame;
the quantum bar accommodates in the cavity of the groove, one end of which abut with the bottom of the inner wall of groove;
the middle frame cover is disposed on the light guide plate and the light source, one side of which facing to the back board is provide with a first buffer block abutting on the other end of the quantum bar, the first buffer block is attached on the middle frame.

11. The backlight module as claimed in claim 10, wherein the height of the incident light side of the light guide plate is greater than the light emitting side.

12. The backlight module as claimed in claim 11, wherein the length of the quantum bar is greater than or equal to the height of the light emitting side of the light guide plate.

13. A liquid crystal device, wherein it comprises a backlight module, the backlight module comprises a back board, a light guide plate, a light source, a middle frame and a quantum bar;
wherein the light guide plate is disposed between the back board and the middle frame, which comprises the incident light side and the light emitting side, the incident light side is close to the light source, which is provided with a groove of which the opening faces to the middle frame;
the quantum bar accommodates in the cavity of the groove, one end of which abut with the bottom of the inner wall of groove;
the middle frame cover is disposed on the light guide plate and the light source, one side of which facing to the back board is provide with a first buffer block abutting on the other end of the quantum bar.

14. The backlight module as claimed in claim 13, wherein the first buffer block is attached on the middle frame.

15. The backlight module as claimed in claim 14, wherein the length of the quantum bar is greater than or equal to the height of the light emitting side of the light guide plate.

16. The backlight module as claimed in claim 15, wherein the incident light side of the light guide plate (2) is provided with at least one heat sink, the heat sink is connected with the groove, and runs through the outer side wall of the incident light side of the light guide plate facing to the back board side.

17. The backlight module as claimed in claim 16, wherein the backlight module also comprises a second buffer block, the second buffer block is disposed between the back board and the incident light side of the light guide plate.

18. The backlight module as claimed in claim 17, wherein the backlight module also comprises a heat sink, the heat sink is disposed between the second buffer block and the back board.

19. The backlight module as claimed in claim 18, wherein the thickness of the light guide plate gradually decreases along with the direction of the light emitting side away from the light source.

20. The backlight module as claimed in claim 19, wherein the backlight module also comprises a reflective sheet, the reflective sheet is disposed on the one side of the light emitting side of the light guide plate facing to the back board; the material of the middle frame is made of a plastic material.
